(19) United States
(12) Patent Application Publication
(10) Pub. No.: US 2005/0141131 A1
(43) Pub. Date: Jun. 30, 2005

(54) System and method for time varying filter for seek acoustics reduction

(75) Inventors: Thorsten Schmidt, Milpitas, CA (US); Feei Y. Chung, Cupertino, CA (US)

Correspondence Address: FLIESLER MEYER, LLP, FOUR EMBARCADERO CENTER, SUITE 400, SAN FRANCISCO, CA, 94111, US

(73) Assignee: Matsushita Electric Industrial Co., Ltd., Kadoma-shi (JP)

(21) Appl. No.: 11/004,398

(22) Filed: Dec. 3, 2004

Related U.S. Application Data
(60) Provisional application No. 60/532,423, filed on Dec. 24, 2003.
(60) Provisional application No. 60/532,424, filed on Dec. 24, 2003.

(51) Int. Cl. G11B 5/596

(52) U.S. Cl. 360/78.07

(57) ABSTRACT

A filter is provided to filter the command current during portions of the seek operation. In one embodiment, a low pass filter is used during the early portions of the seek operation to reduce the acoustical clicking and modified filters are used for later portions. In one embodiment, the modified filter arrangement gradually removes the filter by the end of the seek operation. In this way, the filter is not presented in the track following mode.

### CLAIMS OF PRIORITY

This application claims priority to U.S. Provisional Application No. 60/532,423 entitled “Time Varying Filter for Seek Acoustics Reduction” filed Dec. 24, 2004 and U.S. Provisional Application No. 60/532,424 entitled “Method for Varying Filter for Seek Acoustics Reduction” filed Dec. 24, 2003.

### FIELD OF THE INVENTION

The present invention relates to the performance of rotating media storage devices, such as Hard Disk Drives (HDDs), especially to servomechanisms for arm actuators.

### BACKGROUND

Rotating media storage devices are an integral part of computers and other devices with needs for large amounts of reliable memory. Rotating media storage devices are inexpensive, relatively easy to manufacture, forgiving where manufacturing flaws are present, and capable of storing large amounts of information in relatively small spaces.

A typical rotating media storage device uses a rotatable storage medium with a head disk assembly and electronics to control operation of the head disk assembly. The head disk assembly can include one or more disks. In a magnetic disk drive, a disk includes a recording surface to receive and store user information. The recording surface can be constructed of a substrate of metal, ceramic, glass or plastic with a thin magnetizable layer on either side of the substrate. Data is transferred to and from the recording surface via a head mounted on an arm of the actuator assembly. Heads can include one or more read and/or write elements, or read/write elements, for reading and/or writing data. Drives can include one or more heads for reading and/or writing. In magnetic disk drives, heads can include a thin film inductive write element and a magneto-resistive (MR) read element.

An actuator, such as a Voice Coil Motor actuator, is used to position the head assembly over the correct track on a disk by rotating the arm. Typically, when the drive needs to move the head to a desired track, if the head is relatively far form that track, it starts out in a non-linear seek mode where the target velocity approximates a square root of the tracks to go (TTG). Once the head gets close to the target track, the drive typically switches over to a settle mode where the target velocity is a linear function of the tracks to go. Finally, once the head gets close enough to the target track for read/write operations, the drive then switches to a track-following mode. Typically, the same linear control law as in the settle mode is used, except with different parameters.

### BRIEF DESCRIPTION OF THE DRAWINGS

FIG. 1 is a diagram of a rotating media storage device of one embodiment of the present invention.

FIG. 2A is a diagram that illustrates position versus time for the seek operation on a hard disk drive for one embodiment.

FIG. 2B is a diagram that illustrates actuator arm velocity versus seek time.

FIG. 2C illustrates a diagram of the current versus time for seek operation.

FIG. 3 is diagram illustrating a control unit and physical unit of one embodiment of the present invention.

FIG. 4A is a diagram that illustrates the command current versus the time for seek operation.

FIG. 4B is a diagram that illustrates filter coefficient versus time in the embodiments of the present invention in which the filter arrangement changes during the seek.

### BRIEF SUMMARY

Audible clicks can be a problem with rotating media storage devices, such as hard disk drives. Clicking can occur due to sharp transients in the command current. The transitions are especially a problem for short seek distances. One embodiment of the present invention filters a command signal using multiple filter arrangements during a seek.

The filter characteristics can be changed to provide a low pass filter for other portions of the seek in order to reduce the acoustical clicking that can occur during seek. The passband of the filter can be increased during other portions of the seek. In one embodiment, by the end of the seek, the filter is substantially removed. In this way, in the track following mode, no filter need be used.

### DETAILED DESCRIPTION

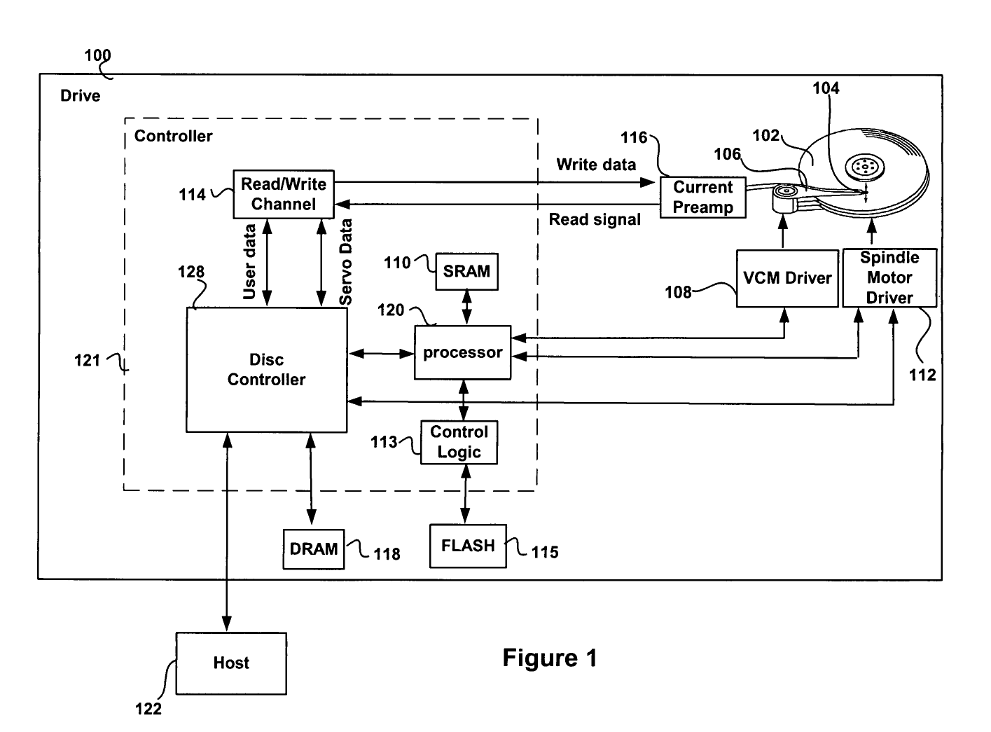

FIG. 1 shows a rotating media storage device 100 that can be used in accordance with one embodiment of the present invention. In this example, the rotating media storage device 100 is a hard disk drive. The rotating media storage device 100 includes at least one rotatable storage medium 102 capable of storing information on at least one surface. Numbers of disks and surfaces may vary by disk drive. In a magnetic disk drive, the storage medium 102 is a magnetic disk. A closed loop servo system, including an actuator arm 106, can be used to position head 104 over selected tracks of disk 102 for reading or writing, or to move head 104 to a selected track during a seek operation. In one embodiment, head 104 includes a magnetic transducer adapted to read data from and write data to the disk 102. In another embodiment, head 104 includes separate read elements, such as magnetoresistive (MR) read heads, and write elements. Multiple head configurations may be used.

The servo system can include an actuator unit 108, which may include a voice coil motor driver to drive a voice coil motor (VCM) for rotating the actuator arm 106. The servo system can also include a spindle motor driver 112 to drive a spindle motor (not shown) for rotation of the disk 102. Controller 121 can be used to control the rotating media storage device 100. The controller 121 can include a number of arrangements. In one embodiment, the controller includes a disk controller 128, read/write channel 114, processor 120, SRAM 110, and control logic 113 on one chip. These elements can also be arranged on multiple chips. The controller can include fewer elements as well.

In one embodiment, the controller 121 is used to control the VCM driver 108 and spindle motor driver 112, to accept information from a host 122 and to control many disk functions. A host can be any device, apparatus, or system capable of utilizing the data storage device, such as a personal computer or Web server. The controller 121 can include an interface controller in some embodiments for communicating with a host and in other embodiments, a separate interface controller can be used. The controller 121 can also include a servo controller, which can exist as circuitry within the drive or as an algorithm resident in the controller 121, or as a combination thereof. In other embodiments, an independent servo controller can be used.

Disk controller 128 can provide user data to a read/write channel 114, which can send signals to a current amplifier or pre-amp 116 to be written to the disk(s) 102 and can send servo signals to the microprocessor 120. Controller 121 can also include a memory controller to interface with memory such as the DRAM 118 and FLASH memory 115. FLASH memory 115 can be used as non-volatile memory to store a code image. DRAM 118 can be used as a buffer memory and to store the code to be executed along with the SRAM 110.

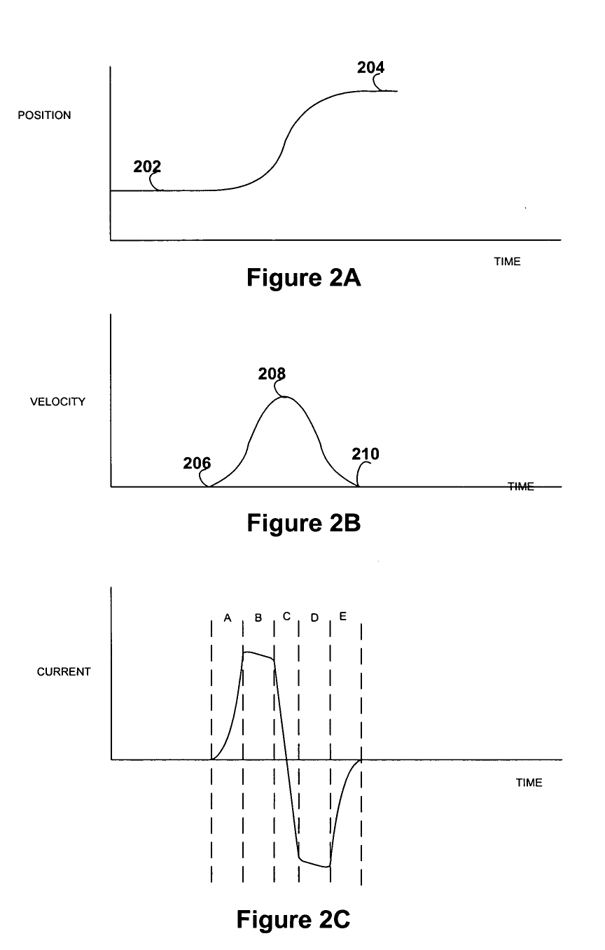

FIG. 2A illustrates a graph of position versus time for a seek operation. In this example, the actuator arm moves from position 202 to position 204.

FIG. 2B illustrates the velocity change of the actuator arm. The velocity increases from starting position 206 to peak 208 and then declines to point 210.

FIG. 2C illustrates a command current provided to the actuator to control the actuator arm during the seek operations. In region A, the command current is rapidly increased to a maximum. In region B, the command current saturates. As the mid point is reached, in region C, the command current is reversed rapidly in order to provide for quick deceleration. In region D, the command current saturates in the opposite direction.

The applicants have determined that the acoustical clicking is most likely to occur in regions A and C. In one embodiment, a low pass filters is applied during a portion of the seek including regions A and C. A different low pass filter (different filter characteristic) can be applied during regions D and E. In one embodiment, the passband of the filter is increased during regions D and E. In one embodiment, by the end of region E, the filter is substantially removed.

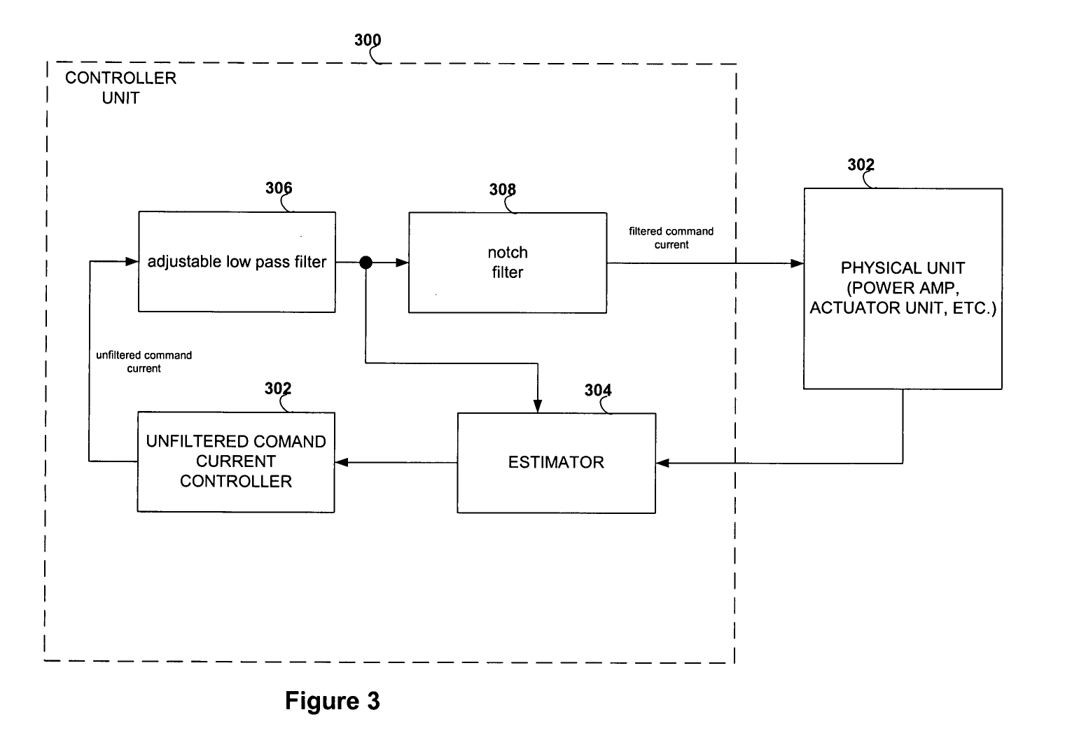

FIG. 3 illustrates an example of a controller unit 300 and a physical unit 302 of one embodiment. The controller 300 uses information such as the Position Error Signal (PES), target velocity and actual velocity to determine an unfiltered command current in the unfiltered command current controller 302. The PES signal target and estimated velocity can be produced in the estimator 304, which produces estimates for the unfiltered command current controller 302. The unfiltered command current controller 302 can be a conventional controller such as the Proximate Time Optimal Servo (PTOS) or another controller.

The unfiltered command current is sent to an adjustable low pass filter 306. The filter arrangement of the adjustable low pass filter 306 can be changed during the different regions or portions of the seek operation. The notch filter 308 filters at resonant frequency or frequencies of the physical unit 302. The signals from the adjustable low pass filter 306 can be provided back to the estimator 304. The notch filtered command current can be sent to the physical unit 302. The command current can be converted to an analog value and the power amplifier in the physical unit 302 can amplify the signal provided to the actuator unit. The actuator unit causes the actuator arm to move under control of the command current.

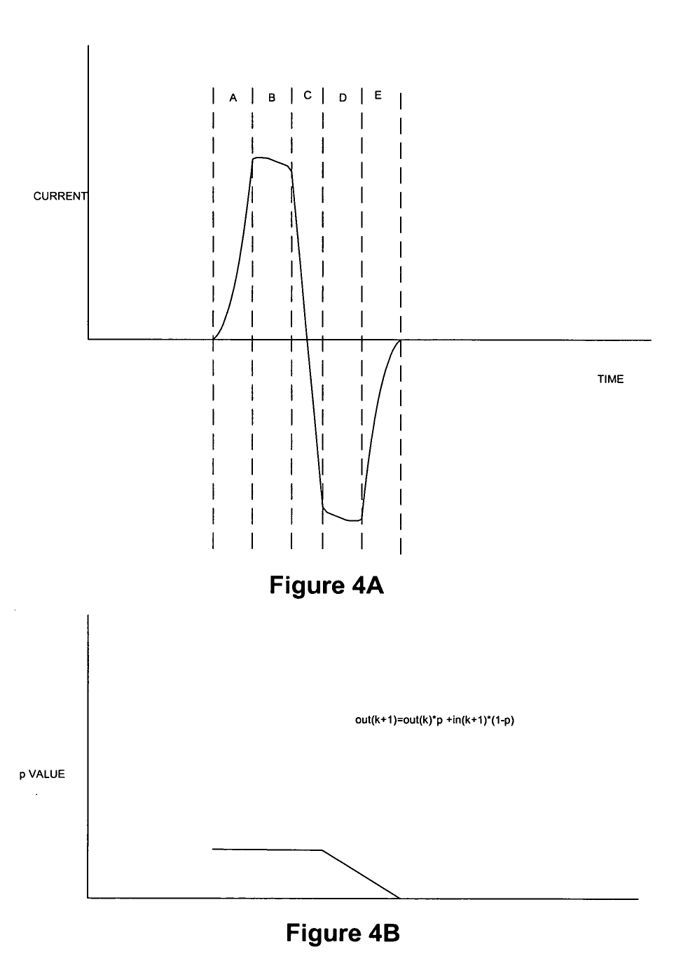

FIG. 4A illustrates an example of the filtered command current versus time of one embodiment. FIG. 4B illustrates one example of a filter. In this example, the filter is infinite impulse response filter using coefficient p. In this example, the coefficient p, can be a constant which results in a constant low pass filter during the portions of the seek operation corresponding to regions A, B and C. During regions D and E the coefficient can be reduced. Once the p value reaches 0, the filter is effectively removed. This has the advantage that during the track following operations there is no filter to interfere with the operations of the system in that mode.

One embodiment of the present invention concerns calculating a command signal for a seek operation on a hard disk drive. The command signal can be the conventional unfiltered command current value. The command signal can be filtered using a first filter arrangement for the first portions of the seek operation. The first portion of the seek operation can be for example regions A and C shown in FIG. 4A. These are the regions that typically result in acoustical clicking. The command signal can be filtered using a modified filter arrangement for second potion of the seek operation. In one embodiment, the modified filter arrangement is a low pass filter with an increasing passband. Looking again at FIG. 4B, region A can be considered to be the current increase region, region C can be considered to be the current reverse region and region E can be considered to be the current decrease region.

The foregoing description of preferred embodiments of the present invention has been provided for the purpose of illustration and description. It is not intended to be exhaustive or to limit the invention to the precise forms disclosed. Many modifications and variations will be apparent to one of the ordinary skill in the relevant arts. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

1. A hard disk drive comprising:
an actuator unit
a controller producing command signals for the actuator unit, the command signals being filtered using a first filter arrangement for a first portion of the seek operation and filtered using a modified filter arrangement for a second portion of the seek operation.

2. The hard disk drive of claim 1, wherein the command signal is an unfiltered command current value.

3. The hard disk drive of claim 1, wherein the filtered command signal is used to control the actuator unit.

4. The hard disk drive of claim 1, wherein the first filter arrangement is a lowpass filter.

5. The hard disk drive of claim 4, wherein the first filter arrangement is fixed in the first portion.

6. The hard disk drive of claim 1, wherein the second filter arrangement is a low pass filter.

7. The hard disk drive of claim 6, wherein the second filter arrangement is a low pass filter with an increasing pass band.

8. The hard disk drive of claim 1, wherein the first portion includes a current increase and current reversal region.

9. The hard disk drive of claim 1, wherein the second portion includes a current decrease region.

10. A method comprising:
calculating a command signal for a seek operation on a hard disk drive;
filtering the command signal using a first filter arrangement for a first portion of the seek operation; and
filtering the command signal using a modified filter arrangement for a second portion of the seek operation.

11. The method of claim 10, wherein the command signal is an unfiltered command current value.

12. The method of claim 10, wherein the filtered command signal is used to control an actuator unit.

13. The method of claim 10, wherein the first filter arrangement is a lowpass filter.

14. The method of claim 13, wherein the first filter arrangement is fixed in the first portion.

15. The method of claim 10, wherein the modified filter arrangement is a low pass filter.

16. The method of claim 15, wherein the modified filter arrangement is a low pass filter with an increasing pass band.

17. The method of claim 10, wherein the first portion includes a current increase and current reversal region.

18. The method of claim 10, wherein the second portion includes a current decrease region.
